(19) United States
(12) Patent Application Publication
(10) Pub. No.: US 2009/0287348 A1
(43) Pub. Date: Nov. 19, 2009

(54) CONTROL APPARATUS AND METHOD FOR AN AUTOMATIC DISPENSER

(75) Inventor: Ignazio FIUME, Ottilio (AL) (IT)

Correspondence Address: HAMRE, SCHUMANN, MUELLER & LARSON, P.C., P.O. BOX 2902, MINNEAPOLIS, MN, 55402-0902, US

(73) Assignee: EMMEQUADRO SRL, Sirmione (BS) (IT)

(21) Appl. No.: 12/467,655

(22) Filed: May 18, 2009

(30) Foreign Application Priority Data
May 19, 2008 (IT) UD2008A000110

(51) Int. Cl. G06F 7/00

(52) U.S. Cl. 700/231

(57) ABSTRACT

A control apparatus for an automatic dispenser provided at least with a display device and a processing and command unit. The control apparatus comprises at least first sensor elements able to detect at least the presence of an image reproduced by the display device and to transmit the data detected to the processing and command unit, which is able to vary the operating and/or functional conditions of the display device and/or of the automatic dispenser according to the data detected.

### FIELD OF THE INVENTION

The present invention concerns an apparatus and the relative method to control an automatic dispenser, such as for example a cash dispenser, a cashpoint, a dispenser of goods and services and other, provided with a display device such as a monitor or suchlike.

The present invention also concerns the display device and the processing and command unit of said automatic dispenser.

In particular, the apparatus according to the invention is able to be used, preferably but not exclusively, to carry out a control, for example of the remote type, of the functioning and state of service of the display device with which the automatic dispenser is normally provided.

Here and hereafter in the description we shall refer specifically to the application of the invention to cash dispensers for dispensing money, but this does not mean that the present invention cannot be equally applied to any other type of automatic dispenser provided with a display device.

### BACKGROUND OF THE INVENTION

Cash dispensers are known, provided with a display device and a plurality of peripherals such as, typically, a unit to dispense the bank notes, a reader for the cash dispenser card, a printer to print payment slips, a security unit and a keyboard. Known cash dispensers also comprise a processing and command unit, provided with management software, able to control and manage the functioning of said peripherals.

One disadvantage of such cash dispensers is that the processing and command unit and the relative software are not suitable to control and manage the display device.

This means that it is impossible, for example, to assess when the display device is broken, so that the management software remains operational even when the display device malfunctions and is switched off. In such circumstances the cash dispenser is not able to supply a correct service to users and moreover, in this situation, the cash dispenser is more vulnerable to possible frauds by ill-intentioned persons.

Furthermore, it is not possible to automatically regulate, for example, the rear illumination of the display device according to the surrounding light, particularly when the display devices are exposed to sunlight. Therefore, in order to guarantee that the user can see properly in every environmental condition, display devices are used having a rear illumination with great luminosity, provided with lamps or display devices with a cathode tube, containing substances that are not environmentally friendly, such as mercury, cadmium, lead, or other similar substances, with high energy consumption and the consequent costs.

Moreover, the adjustment of the parameters of the display devices, such as luminosity, contrast, sharpness and other known parameters, normally made manually by a specialized technician, entail laborious and inconvenient operations. Indeed, since the cash dispenser is normally in a wall, the technician has to remove the display device, carry out the adjustments from inside the building or room where the cash dispenser is installed, replace the device and subsequently, to verify the effect of the adjustments, leave the building or room and possibly return inside in order to optimize the adjustments.

One purpose of the present invention is to achieve an apparatus and a method to control cash dispensers that allows to interrupt the automatic dispenser service when the display device of the dispenser is broken.

Another purpose of the present invention is to achieve an apparatus and a method to control cash dispensers that allows to control and manage the display device of the dispenser in order to carry out an easy adjustment of the parameters of the display device without having to remove it from its place of operations.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purposes, a control apparatus according to the present invention is able to be used, preferably but not only, in an automatic dispenser, such as for example a cash dispenser, a cashpoint or other, provided at least with a display device and a processing and command unit so as to control, advantageously, the functioning of said display device.

According to a characteristic feature of the present invention, the apparatus comprises at least first sensor means able to detect at least the presence of an image reproduced by the display device and to transmit the data detected to the processing and command unit, which is able to vary the operating and functional conditions of the display device and/or the automatic dispenser according to the data detected.

Advantageously the processing and command unit is able to render the automatic dispenser inactive in the event that the image reproduced by said display device is not detected by said first sensor means.

According to a variant of the present invention the apparatus also comprises a visual signaling device to signal the inactivity of the automatic dispenser, able to be activated by the processing and command unit.

In this way, the non-detection of said images by the first sensor means substantially corresponds to a malfunctioning and/or accidental switching off of the display device. Therefore, the processing and command unit provides to render the management software inoperative, consequently suspending the service of the automatic dispenser and preventing it from dispensing/accepting money.

The use of a visual signaling device to signal the inactivity of the automatic dispenser, for example of the electromagnetic or optoelectronic type, also allows to notify the user that the automatic dispenser is unavailable in the event of a malfunction of the display device.

According to a variant of the present invention, the apparatus also comprises second sensor means able to detect the light intensity of the environment surrounding the automatic dispenser, and to transmit said information to the processing and command unit so that the latter varies the parameters of the display device, such as the luminosity, contrast and other similar parameters, according to said information.

According to another variant, the apparatus also comprises third sensor means, advantageously proximity sensors, able to detect the presence or absence of a user in the proximity of the automatic dispenser and to transmit said information to the processing and command unit so that the latter varies the luminosity of the display device, according to the presence or absence of the user.

According to another variant of the present invention, the apparatus also comprises fourth sensor means, advantageously infrared sensors, able to be used to effect a remote adjustment of the O.S.D. (On-Screen Display) type, by means of a remote control with a secure communication protocol, of the display device, for example when the automatic dispenser is set up, in order to vary significant parameters of the display device easily, such as for example contrast, luminosity, sharpness and other similar parameters, without having to remove it from its place of operations.

Therefore, the use of the sensor means allows to control and manage the display device of the automatic dispenser and to carry out an easy and substantially automatic adjustment of the parameters of the display device, so as to have always the best display conditions for the user and a considerable saving in terms of time.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a schematic representation of an apparatus according to the present invention.

### DETAILED DESCRIPTION OF A PREFERENTIAL FORM OF EMBODIMENT

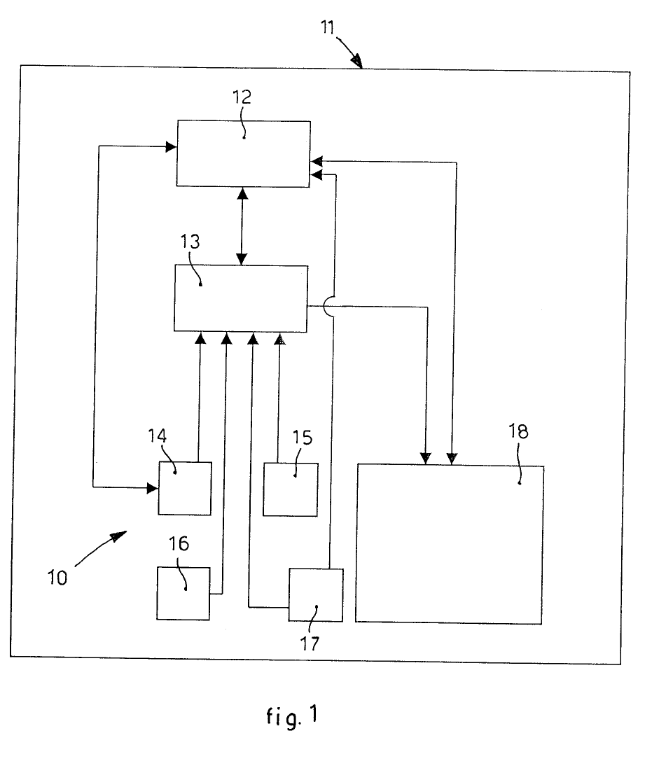

With reference to FIG. 1, a control apparatus 10 for an automatic dispenser such as a cash dispenser 11 is able to be used, preferably but not only, to manage and control a display device 12 with which a cash dispenser 11 is normally provided.

The apparatus 10 is associated with a processing and command unit 13 of the cash dispenser 11, provided with a management software so as to manage the cash dispenser operations, and with the display device 12, and comprises a first optical sensor, or guard sensor 14, advantageously positioned in correspondence with a portion of the display device 12 that is little used or not at all used by the graphic interfaces of the management software, so as not to interfere with the operations that a user has to make.

It is understood that the guard sensor 14 is able to be located in any position whatsoever, associated with the cash dispenser 11 or disposed around it, so that its field of action is in any case in correspondence with said portion.

The guard sensor 14 is able to detect the presence or absence of a control image, reproduced on the display device 12. The guard sensor 14 is able to transfer the information relating to the presence or absence of the control image to the processing and command unit 13.

The control image is generated by a control software installed in the processing and command unit 13 so as to coexist with the management software already present in the processing and command unit 13.

Advantageously the control image comprises, for example, a sequence of colored bars, for example blue, green and red, in which the succession of said colors is changed alternately, thus achieving all the possible combinations of said colors. This image allows to verify the chromatic alternation of the pixels of the display device 12 in correspondence with the zone where the control image is reproduced, and consequently whether the display device 12 is functioning or not.

According to a variant of the present invention the guard sensor 14 comprises a plane scanner associated with the display device 12.

The plane scanner is able to detect the presence of the image generated by the management software and reproduced on the display device 12. Since the image is in itself already luminous, it is projected by means of a configuration of mirrors and prisms in correspondence with a CCD sensor, and detected there.

The apparatus 10 according to the present invention also comprises a crepuscular sensor 15, able to detect the light intensity of the environmental light and to transmit this information to the processing and command unit 13 in order to automatically regulate the luminosity of the display device 12 as the environmental light diminishes/increases. In this way, during the night hours, when the use of the cash dispenser 11 is considerably reduced, the luminosity of the display device 12 is not needlessly excessive.

The apparatus 10 also comprises a proximity sensor 16 able to detect the presence or absence of a user in the proximity of the cash dispenser 11. This information is able to be sent to the processing and command unit 13 which is able to limit the luminosity of the display device 12 if there are no users near the cash dispenser 11, and to increase the luminosity of the display device 12 when there is a user near the cash dispenser 11.

The apparatus 10 also comprises an infrared sensor 17 to effect a remote adjustment of the O.S.D. type by means of a remote control with a secure communication protocol, in order to vary significant parameters of the display device 12 easily, such as for example contrast, luminosity, sharpness and other similar parameters.

The apparatus 10 also comprises a visual signaling device to signal the inactivity of the automatic dispenser, or “out of order” device 18.

In a first form of embodiment, the “out of order” device 18, associated with the processing and command unit 13, comprises a tubular element, advantageously made of plastic material, located in correspondence with the upper edge of the display device 12, inside which a rolled curtain is contained bearing the words “out of order”. The “out of order” device 18 also comprises a spring, advantageously of the helicoidal type, able to keep the curtain rolled up, and an electromagnet, in turn able to block the curtain in the rolled condition. The “out of order” device 18 also comprises a motor to roll up the curtain and two springs, located in corresponding tubular elements disposed along the vertical sides of the display device 12.

In a second form of embodiment, the “out of order” device 18 comprises a laser diode, activated by the processing and command unit 13, able to illuminate a hologram bearing the words “out of order”, advantageously located on the base of the display device 12.

The control apparatus 10 according to the present invention as described heretofore functions as follows.

The guard sensor 14 continuously detects the presence or absence of the control image on the display device 12 and communicates this information to the processing and command unit 13.

If the guard sensor 14 does not detect the control image, this corresponds to a malfunction and/or to the accidental switching off of the display device 12. If the guard sensor 14 does not detect the control image, the processing and command unit 13, based on this information, interrupts the cash dispenser service, and renders the management software inoperative.

Following this, the processing and command unit 13, suitably fed by a continuous feed device, also activates the visual signaling device 18 to signal the inactivity of the automatic dispenser. In particular, in said first form of embodiment of the “out of order” device 18, the electromagnet is excited so as to de-activate its blocking function and allow the springs disposed along the vertical sides of the display device 12 to overcome the elastic force of attraction of the helicoidal spring, making the curtain descend with the relative words.

In the second form of embodiment the processing and command unit 13 activates the laser diode. The light emitted by the laser diode hits the hologram and consequently allows it to be displayed.

When the functioning of the display device 12 is restored, in the first form of embodiment of the “out of order” device 18, the processing and command unit 13 activates the motor to allow the curtain to be rolled up, whereas, in the second form of embodiment it de-activates the emission of light of the laser diode and interrupts the projection of the hologram.

When the display device 12 is recognized as functioning, the crepuscular sensor 15 detects the light intensity of the environmental light and transmits this information to the processing and command unit 13 so as to automatically regulate the luminosity of the display device 12 as the environmental light diminishes.

Simultaneously, the proximity sensor 16 detects the presence or absence of a user in the proximity of the cash dispenser 11 and transfers said information to the processing and command unit 13. The latter limits the luminosity of the display device 12 when there are no users in the proximity of the cash dispenser 11, and increases the luminosity of the display device 12 when there is a user in the proximity of the cash dispenser 11.

The infrared sensor 17 is used, for example by a specialized technician when the cash dispenser 11 is set up, in order to effect an adjustment of the O.S.D. type by means of a remote control with a secure protocol. This adjustment allows to vary significant parameters of the display device 12 easily, such as for example contrast, luminosity, sharpness and other similar parameters.

It is clear that modifications and/or additions of parts may be made to the control apparatus 10 for an automatic dispenser as described heretofore, without departing from the field and scope of the present invention.

It is also clear that, although the present invention has been described with reference to some specific examples, a person of skill in the art shall certainly be able to achieve many other equivalent forms of control apparatus for an automatic dispenser, having the characteristics as set forth in the claims and hence all coming within the field of protection defined thereby.

1. A control apparatus for an automatic dispenser provided at least with a display device and a processing and command unit, comprising at least first sensor means able to detect at least the presence of an image reproduced by said display device and to transmit the data detected to said processing and command unit, which is able to vary the operating and/or functional conditions of said display device and/or of said automatic dispenser according to said data detected.

2. The control apparatus as in claim 1, wherein the processing and command unit is able to render inactive the automatic dispenser in the event that said first sensor means do not detect said image.

3. The control apparatus as in claim 2, comprising a visual signaling device to signal the inactivity of the automatic dispenser able to be activated by said processing and command unit.

4. The control apparatus as in claim 1, further comprising second sensor means able to detect the light intensity of the environment surrounding said automatic dispenser.

5. The control apparatus as in claim 4, wherein said second sensor means comprise at least a sensor of the crepuscular type.

6. The control apparatus as in claim 1, further comprising third sensor means able to detect the presence/absence of a user in the proximity of said automatic dispenser.

7. The control apparatus as in claim 6, wherein said third sensor means comprise at least a sensor of the proximity type.

8. The control apparatus as in claim 1, further comprising fourth sensor means able to be used to effect a remote adjustment of the parameters of the display device.

9. A control method for an automatic dispenser provided at least with a display device and a processing and command unit, comprising at least a step in which first sensor means detect at least the presence of an image reproduced by said display device and transmit the data detected to said processing and command unit, which varies the operating and/or functional conditions of said display device and/or of said automatic dispenser according to said data detected.

10. The control method as in claim 9, comprising at least an interruption step in which the processing and command unit renders inactive the automatic dispenser in the event that said first sensor means do not detect said image.

11. The control method as in claim 10, wherein said interruption step comprises at least a sub step in which the processing and command unit activates a visual signaling device to signal the inactivity of the automatic dispenser.

12. The control method as in claim 9, comprising at least a step in which second sensor means detect the light intensity of the environment surrounding said automatic dispenser and transmit said information to said processing and command unit which varies the parameters of the display device according to said information.

13. The control method as in claim 9, comprising at least a step in which third sensor means detect the presence/absence of a user in the proximity of said automatic dispenser and transmit said information relating to the presence/absence of a user to said processing and command unit, which varies the parameters of the display device according to said information relating to the presence/absence of a user.

14. The control method as in claim 9, comprising at least a step in which fourth sensor means are used to effect a remote adjustment of the parameters of the display device.

15. A processing and command unit for an automatic dispenser provided at least with a display device, the processing and command unit being able to vary the operating and/or functional conditions of said display device and/or of said automatic dispenser according to data detected by first sensor means of a control apparatus able to detect at least the presence of an image reproduced by said display device.

16. The processing and command unit as in claim 15, being able to render inactive the automatic dispenser in the event that said image is not detected by said first sensor means.

17. The processing and command unit as in claim 16, being able to activate a device to signal the inactivity of the automatic dispenser.

18. A display device for an automatic dispenser provided at least with a processing and command unit, the display device being associated with a control apparatus comprising at least first sensor means able to detect at least the presence of an image reproduced by said display device and to transmit the data detected to said processing and command unit, which is able to vary the operating and/or functional conditions of said display device and/or of said automatic dispenser according to said data detected.
